(19) United States
(12) Patent Application Publication
(10) Pub. No.: US 2016/0377464 A1
(43) Pub. Date: Dec. 29, 2016

(54) FLOW METER WITH FLOW DIRECTION SENSING, SEPARABLE FLUID PATH, SUBMERSIBLE ELECTRONIC HOUSING, AND WIRELESS COMMUNICATION CAPACITY

(71) Applicant: ATP, Inc., Hershey, PA (US)

(72) Inventors: Daniel Todd Adlon, Harrisburg, PA (US); Joseph Bowling, Narberth, PA (US)

(21) Appl. No.: 15/192,396

(22) Filed: Jun. 24, 2016

Related U.S. Application Data
(60) Provisional application No. 62/185,325, filed on Jun. 26, 2015.

(51) Int. Cl. G01F 1/58

(52) U.S. Cl. CPC G01F 1/58

(57) ABSTRACT

A flow meter includes a first body defining a fluid path. A flow measuring element is operatively positioned within the fluid path. The flow measuring element is configured to generate a signal in response to fluid within the fluid path. At least one circuit element is configured to receive the signal generated by the measuring element and determine a rate of flow and a direction of flow of the fluid within the fluid path.

### CROSS-REFERENCE TO RELATED APPLICATIONS

This application claims benefit under 35 U.S.C. §119(e) to U.S. Provisional Application Ser. No. 62/185,325, filed on Jun. 26, 2015, entitled “Improved flow meter with flow direction sensing, separable fluid path, submersible electronic housing, and wireless communication capability,” which is herein incorporated by reference in its entirety.

### BACKGROUND

Flow meters are used to measure linear, non-linear, mass, and/or volumetric flow rate of a liquid or a gas. Measurements are generally related to a materials density. Current flow meters can provide a rate of flow for a liquid but are unable to differentiate direction of flow and therefore provide inaccurate flow rates in applications involving bi-direction flow of fluid. Further, current flow meters are able to monitor only a single fluid source and a single direction of flow.

### SUMMARY

In various embodiments, a flow meter is disclosed. The flow meter includes a flow path cartridge coupled to an electronics module. The flow path cartridge includes a body defining a fluid path and a flow measuring element operatively positioned within the fluid path. The electronics module is configured to determine a rate of flow and a direction of flow of a fluid in the fluid path.

In various embodiments, a system including a bi-directional flow meter operatively coupled to a fluid channel is disclosed. The bi-direction flow meter includes a first flow path cartridge and an electronics module. The first fluid path cartridge has a body defining a fluid path and a flow measuring element operatively positioned within the fluid path. The flow measuring element includes a paddle wheel having a plurality of paddles operatively positioned within the fluid path and a cylindrically magnetized magnet coupled thereto. The electronics module is releasably coupled to the flow path cartridge. The fluid channel is configured to receive a fluid therethrough. The electronics module is configured to determine a rate of flow and a direction of flow of the fluid in the fluid channel.

In various embodiments, a method of measuring a direction and quantity of flow of a fluid in a fluid channel is disclosed. The method includes coupling a bi-directional flow meter to a first end of the fluid channel. The bi-directional flow meter includes a flow path cartridge releasably coupled to an electronics module. The flow path cartridge includes a body defining a fluid path and a flow measuring element operatively positioned within the fluid path. A fluid is received within the fluid channel and the fluid path defined by the fluid cartridge. A rate of flow of the fluid within the fluid channel is determined by the flow measuring element and a direction of flow of the fluid within the fluid channel is determined by one or more circuit elements in the electronics module.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIGS. 1A-1C illustrate a bi-directional flow meter, in accordance with some embodiments.

FIG. 2 illustrates a cross-sectional side view of a fluid path cartridge, in accordance with some embodiments.

FIG. 3 illustrates a cross-sectional front view of a fluid path cartridge, in accordance with some embodiments.

FIG. 4 illustrates a side view of a fluid path cartridge, in accordance with some embodiments.

FIG. 5 illustrates an exploded view of an electronics module, in accordance with some embodiments.

FIG. 6 illustrates a circuit schematic of the electronics module, in accordance with some embodiments.

FIG. 7 illustrates a system including a bi-directional flow meter and a fluid channel, in accordance with some embodiments.

FIG. 8 illustrates a method of measuring a bi-directional flow of a fluid through a fluid channel, in accordance with some embodiments.

FIG. 9 illustrates a bi-directional flow sensor having a housing including a flow measuring element and a circuit, in accordance with some embodiments.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected,” refer to a relationship wherein structures are secured or attached to one another either directly or indirectly through intervening structures, as well as both movable or rigid attachments or relationships, unless expressly described otherwise.

In various embodiments, a bi-directional flow meter is disclosed. The bi-directional flow meter includes a fluid path cartridge and an electronics module. The fluid path cartridge includes a body defining a fluid path and bi-directional flow element. Fluid flowing through the fluid path interacts with and causes operation of the bi-directional flow measuring element. The fluid path cartridge is coupled to the electronics module. The electronics module includes at least one circuit element configured to detect operation of the bi-directional flow measuring element. The electronics module includes at least one circuit element configured to receive and/or determine flow rate information, such as flow direction and/or flow rate, based on the detected operation of the bi-directional flow measuring element. In some embodiments, the electronics module is configured to transmit the flow rate information to a remote system.

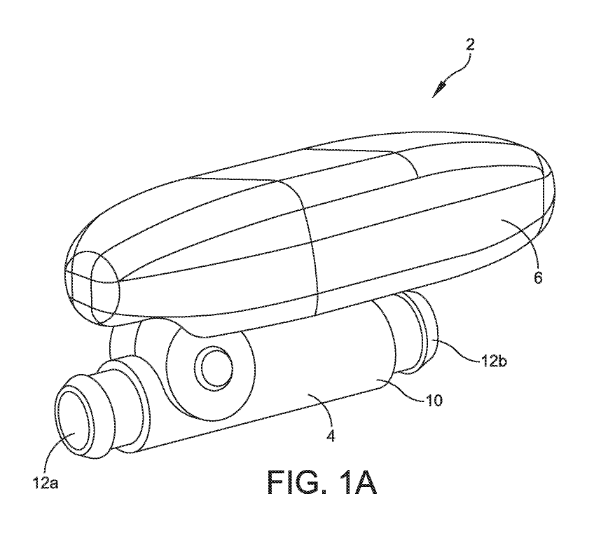

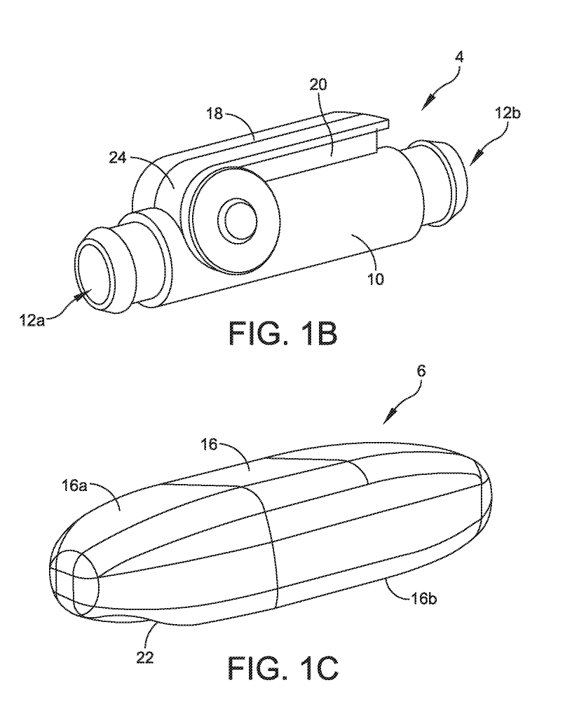

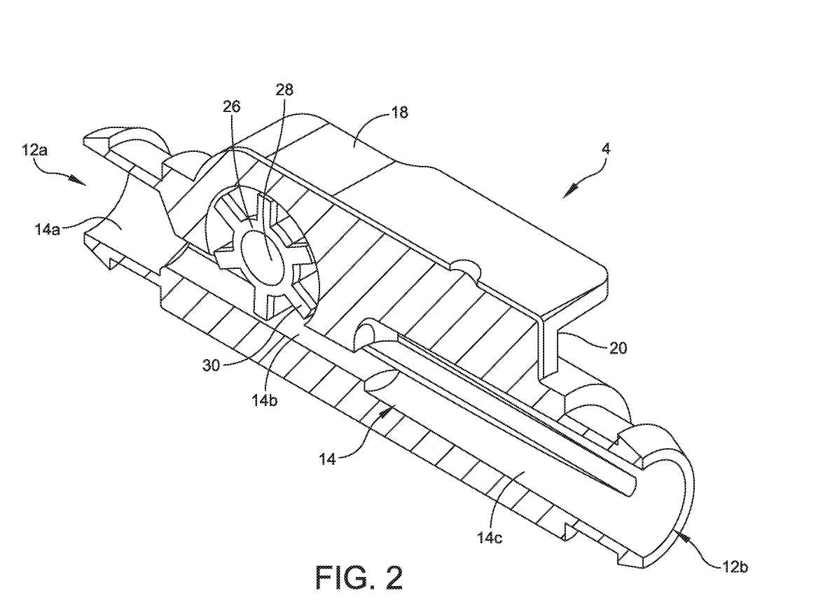

FIG. 1A illustrates a bi-directional flow meter 2, in accordance with some embodiments. The bi-directional flow meter 2 includes a fluid path cartridge 4 and an electronics module 6. The fluid path cartridge 4 can be releasably and/or permanently coupled to the electronics module 6. The fluid path cartridge 4, illustrated in FIG. 1B, includes a body 8 defining a fluid path 10 therethrough. In some embodiments, the fluid path 10 includes a first opening 12a located at a proximal end of the body 8 and a second opening 12b located at a distal end of the body 8. A channel 14 is defined by and extends between the first opening 12a and the second opening 12b (see FIG. 2). In some embodiments, the fluid path 10 extends along a longitudinal axis of the body 8. In other embodiments, the fluid path 10 extends through the body 8 at any suitable angle, such as, for example, parallel to the longitudinal axis, perpendicular to the longitudinal axis, at an angle to the longitudinal axis, and/or any combination thereof.

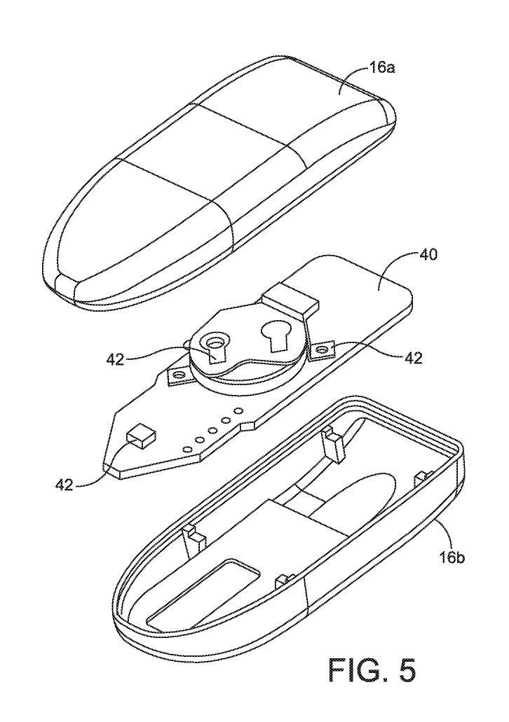

In some embodiments, the electronics module 6 is coupled to the fluid path cartridge 4. The electronics module 6 includes one or more circuit elements configured to flow information of fluid flowing in the fluid path 10, such as the rate and/or direction of fluid flow within the fluid path 10. For example, in some embodiments, the electronics module 6 includes a circuit 40 configured to receive one or more signals from the fluid path cartridge 4 indicative of fluid flow within the fluid path 10 (see FIG. 5). The electronics module 6 includes a housing 16. The electronics module 6 can be hermetically sealed to prevent internal contamination of the electronics module 6 when placed in a fluid.

The fluid path cartridge 4 includes a mating element 18 coupled to the body 8. The mating element 18 is configured to couple the fluid path cartridge 4 to an electronics module 6. The mating element 18 can releasably and/or permanently couple the fluid path cartridge 4 to the electronics module 6. The mating element 18 can include any suitable coupling element. For example. In the illustrated embodiment, the mating element 18 includes a T-shaped beam 20 coupled to an upper portion of the body 8. The T-shaped beam 20 is sized and configured to be received within a corresponding T-shaped slot 22 defined by the housing 16 of the electronics module 6. In other embodiments, the mating element 18 can include an alternatively shaped beam and slot, an adhesive, a hook-and-loop fastener, and/or any other suitable fastener.

In some embodiments, the mating element 18 is configured to allow an angle between the fluid path cartridge 4 and the electronics module 6 to be adjusted. For example, in the some embodiments, the T-shaped beam 20 is coupled to the body 8 by an adjustable hinge 24. The adjustable hinge 24 can be positioned at a plurality of angles with respect to the body 8. For example, in some embodiments, the adjustable hinge 24 can position the T-shaped beam 20 at any angle between 0-90° (inclusive) with respect to the body 8. In other embodiments, the adjustable hinge 24 can be configured to position the T-shaped beam 20 at a greater and/or lesser angle. In some embodiments, the fluid path cartridge 4 is coupled to the electronics module 6 at a fixed angle, such as, for example, any fixed angle between 0°-90° (inclusive).

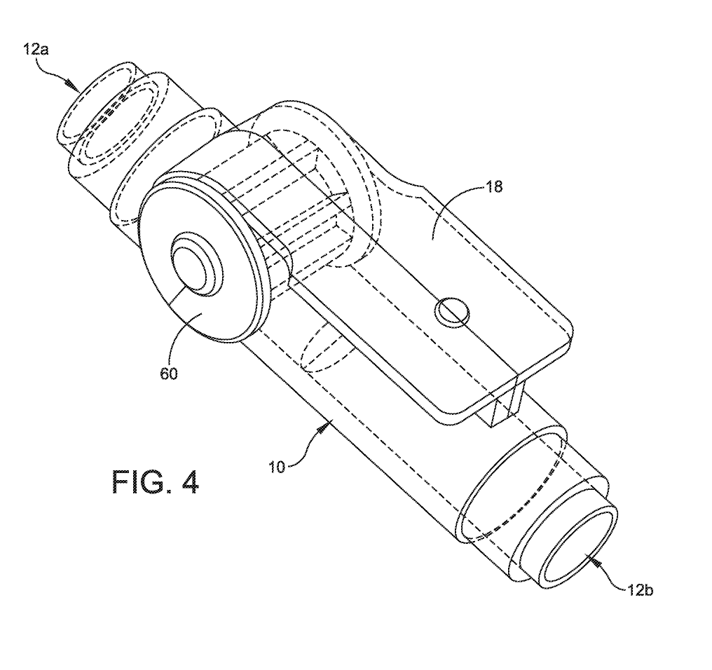

FIGS. 2-4 illustrate a fluid path cartridge 4, in accordance with some embodiments. As shown in FIG. 2, the fluid path 10 defined by the body 8 extends from the proximal side of the body 8 to the distal side. A fluid channel 14 can include two or more sections 14a, 14b, 14c. For example, in the illustrated embodiment, the fluid channel 14 includes a first inlet/outlet section 14a, a flow rate section 14b, and a second inlet/outlet section 14c. The fluid channel 14 can include a variable diameter over the length of the channel, for example, having a different diameter at each of the sections 14a-14c l of the fluid channel 14.

The fluid path cartridge 4 includes a flow measuring element 26 disposed within the body 8 and operatively positioned to measure a flow rate of fluid through the fluid path 10. In some embodiments, the flow measure element 26 includes a mechanical element at least partially disposed in the fluid path 10. For example, in the illustrated embodiment, the flow measure element 26 includes a paddle wheel 28. The paddle wheel 28 is positioned such that a plurality vanes 30a-30f of the paddle wheel 28 extend at least partially into the flow path 10 so as to impart rotation to the paddle wheel 28 when fluid flows through the flow path 10. In other embodiments, the flow measuring element 26 can include any suitable element at least partially disposed within the flow path 10 and configured to respond to fluid movement in both directions within the flow path 10.

In some embodiments, the paddle wheel 28 includes at least one magnetic element 32. The magnetic element 32 is coupled to the paddle wheel 28 such that the magnetic field generated by the magnetic element 32 varies relative to the electronics module 6 coupled to the body 8 when the paddle wheel 28 is rotated by a fluid flow. The rotation of the magnetic element 32 is detected by one or more elements in the electronics module 6 (as discussed in more detail below). In some embodiments, the magnetic element 32 includes a cylindrically magnetized magnet. In some embodiments, the magnetic element 32 includes a plurality of magnets disposed on one or more of the vanes 30a-30f of the paddle wheel 28. Although embodiments are discussed herein including a permanent magnetic element 32, it will be appreciated that the magnetic element 32 can include any suitable magnetic element, such as, for example, one or more permanent magnets, electromagnets, wires, and/or any other suitable magnetic element.

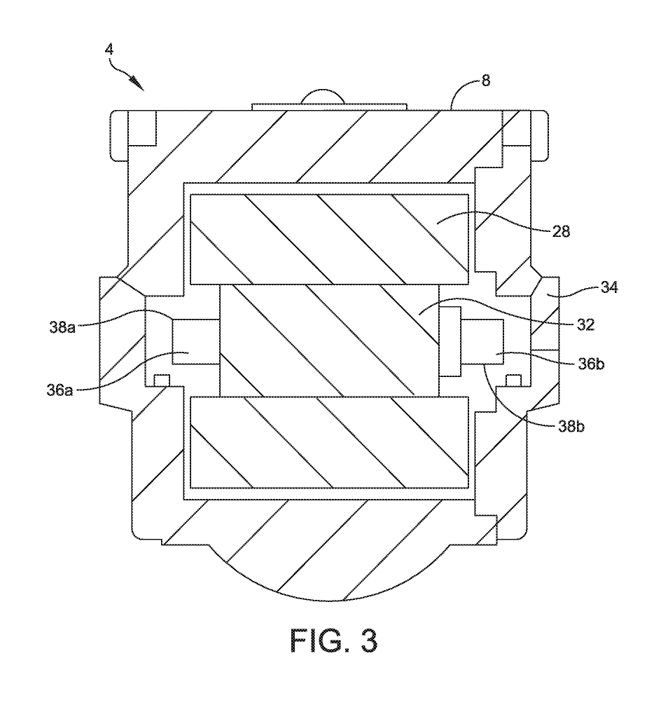

FIG. 3 is a front cross-section of the fluid path cartridge of FIG. 2 in accordance with some embodiments. A cylindrically magnetized magnet 32 is located within the paddle wheel 28. The cylindrically magnetized magnet 32 is maintained in a fixed position by a magnet retainer 34. The cylindrically magnetized magnet 32 is rotated by the paddle wheel 28 when fluid flows through the fluid path 10 and interacts with the vanes 30a-30f of the paddle wheel 28. The rotation of the cylindrically magnetized magnet 32 is detected by one or more circuit elements in the electronics module 6. In some embodiments, the rotation of the cylindrically magnetized magnet 32 is indicative of a direction and/or rate of flow of a fluid within the fluid path 10.

FIG. 3 further illustrates an axle 36 of the magnetic element 32 and/or the paddle wheel 28. In some embodiments, the body 8 defines a first receiving hole 38a and a second receiving hole 38b configured to receive a respective axle portion 36a, 36b therein. The axle portions 36a, 36b are sized and configured to rotate within respective receiving holes 38a, 38. In other embodiments, one or more alternative and/or additional rotational elements can be included to provide for rotation of the paddle wheel 28 and/or a magnetic element 32, such as, for example, one or more bearings.

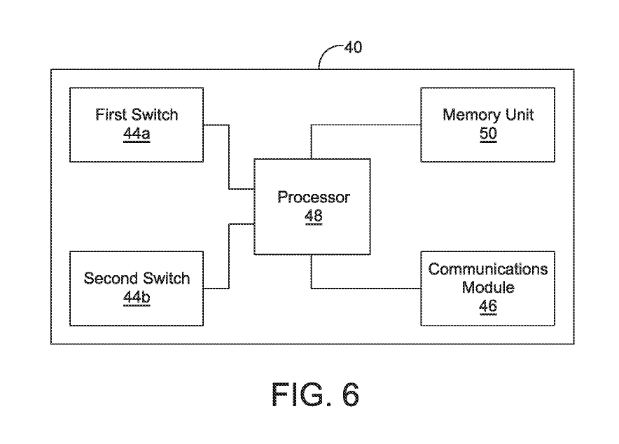

FIG. 5 illustrates an electronics module 6, in accordance with some embodiments. The electronics module 6 includes a housing 16. In some embodiments, the housing 16 includes an upper housing 16a and a lower housing 16b. A circuit 40 is mounted between the upper housing 16a and the lower housing 16b. The circuit 40 includes a plurality of circuit elements 42 configured to perform one or more functions, such as, for example, providing sensing, processing, storage, and/or transmission of flow data acquired from the fluid path cartridge 4. The circuit elements 42 can include one or more switches, sensors, memory units, processors, and/or any other suitable circuit element configured to perform one or more functions of the electronics module 6. FIG. 6 illustrates a schematic diagram of a circuit 40, in accordance with some embodiments.

In some embodiments, the circuit 40 includes at least a first switch 44a and a second switch 44b. The first and second switches 44a, 44b are magnetic switches operated by application of a magnetic field, such as the magnetic field generated by the magnetic element 32 in the fluid path cartridge 4. In some embodiments, the switches 44a, 44b are positioned with respect to the magnetic element 32 such that the switches are operated in a predetermined pattern based on rotation of the magnetic element 32 and the corresponding direction of fluid flow. In some embodiments, a predetermined on/off pattern corresponds to a direction of rotation of the magnetic element 32. For example, in some embodiments, the predetermined activation pattern corresponds to activation of the switches 44a, 44b according to the pattern:

Clockwise Rotation

| | | | |
|---|---|---|---|
| First Switch | OFF | ON | ON |
| Second Switch | ON | ON | OFF |

Counterclockwise Rotation

| | | | |
|---|---|---|---|
| First Switch | ON | ON | OFF |
| Second Switch | OFF | ON | ON |

The pattern of activation of the switches 44a, 44b determines the direction of flow of the fluid. In some embodiments, a first activation pattern corresponds to a clockwise rotation of the paddle wheel 28 and a second activation pattern corresponds to a counterclockwise rotation of the paddle wheel 28. Clockwise rotation of the paddle wheel 28 occurs when the fluid in the fluid path 10 is flowing in a first direction and counterclockwise rotation occurs when the fluid is flowing in a second, opposite direction. When coupled with flow rate information provided by the paddle wheel 28, the electronics module 6 can determine both direction and rate of flow of a fluid in the fluid path 10.

In some embodiments, the electronics module 6 includes a communication module 46. The communication module 46 is configured to provide signal communication between the electronics module 6 and one or more remote systems (not shown). The communication module 46 can be configured as a wired and/or wireless communication module. For example, in some embodiments, the communication module 46 includes a wireless communication circuit configured to provide wireless communication using one or more wireless communication standards, including but not limited to, WiFi, Bluetooth, Near-Field Communication (NFC), and/or any other suitable wireless communication standard.

In some embodiments, the electronics module 6 includes a processor 48 configured to receive signals from one or more circuit elements, such as switches 44a, 44b, communication module 46, and/or one or more additional circuit elements. The processor 48 is configured to perform one or more functions based on the received signals. For example, in some embodiments, the processor 48 is configured to receive inputs from the first switch 44a and the second switch 44b and detect the pattern of activation of the switches 44a, 44b to determine a direction of flow of fluid within the fluid path 10. In some embodiments, the processor 48 receives a signal indicative of the number of rotations of the paddle wheel 28. For example, in some embodiments, the processor 48 determines the number of rotations of the paddle wheel 28 based on the number of complete and/or partial activation patterns of the switches 44a, 44b within a predetermined time period. The number of rotations of the paddle wheel 28 in a predetermined time period corresponds to the rate of flow of the fluid through the fluid path 10.

In some embodiments, the electronics module 6 includes a memory unit 50. The memory unit 50 is configured to store flow information determined and/or received by the processor 48. For example, in some embodiments, the processor 48 determines a direction and/or a rate of flow/total flow amount for a fluid in the fluid path 10. The processor 48 stores the calculated direction and/or amount in the memory unit 50. In some embodiments, the processor 48 alternatively and/or additionally stores raw sensor data, such as the pattern of activation for switches 44a, 44b and/or the number of activation patterns in a predetermined time period, in the memory unit 50. In some embodiments, the memory unit 50 maintains a database (and/or other storage structure) containing a plurality of flow events detected by the bi-directional flow meter 2. For example, in some embodiments, for each of the plurality of flow events, the database includes a date, time, amount of fluid, and direction of fluid flow. In other embodiments, the memory unit 50 retains only those flow events having one or more predetermined characteristics, such as, for example, recording only flow events having a predetermined flow direction.

In some embodiments, the memory unit 50 stores the plurality of flow events until the communication module 46 establishes a connection with a remote device. When the communication module 46 establishes a connection, the processor 48 loads the flow event information from the memory unit 50 and transmits the flow event information to the remote system via the communication module 46. The flow event information can be retained and/or deleted from the memory unit 50 after transmission to the remote system.

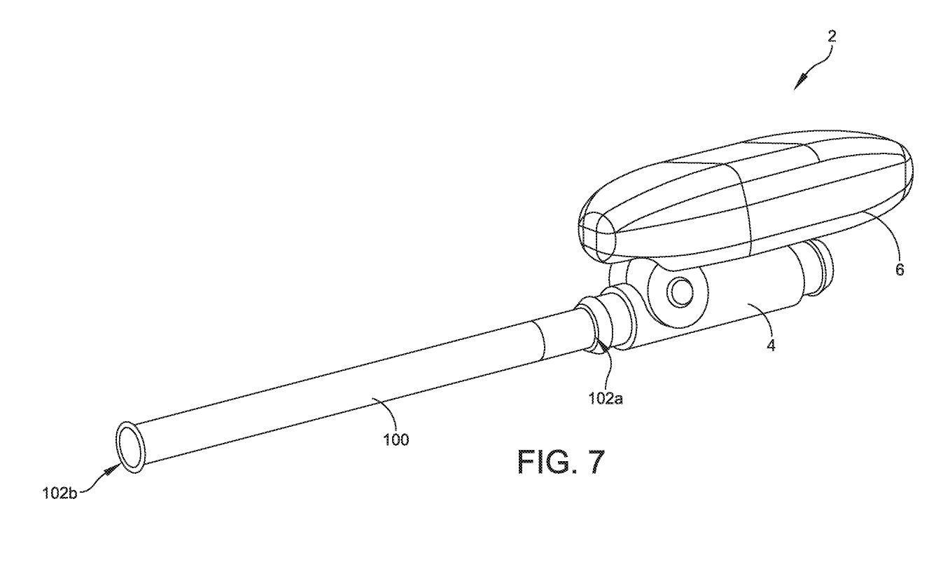

FIG. 7 illustrates one embodiment of a bi-directional flow meter 2 coupled to a fluid channel 100. The bi-directional flow meter 2 is coupled to a first end of the fluid channel 100. Fluid flows into the fluid channel 100 from a fluid source in response to a force applied at a second end 102b of the fluid channel 100. For example, in some embodiments, the fluid channel 100 is a straw having a bi-directional flow meter 2 coupled to a first end 102a and suction applied by a user to a second end 102b. When suction is applied to the second end 102b, fluid from the fluid source flows through the bi-directional flow meter 2 and into the fluid channel 100. The bi-directional flow meter 2 measures the quantity of fluid flowing into the fluid channel 100. When suction is removed from the second end 102b, a portion of the fluid in the fluid path 100 drains through the first end 102a and the bi-directional flow meter 2 back into the fluid source. The bi-directional flow meter 2 is configured to monitor the amount and direction of fluid flow within the fluid channel 100. In some embodiments, the bi-directional flow meter 2 is configured to detect a total amount of fluid flowing in a single direction within the fluid channel 100.

For example, in some embodiments, the bi-directional flow meter 2 and fluid channel 100 can be used to monitor a fluid intake of a user. The bi-directional flow meter 2 is coupled to a fluid channel 100, such as a straw, at a first end 102a. The bi-directional flow meter 2 and a portion of the fluid channel 100 including the first end 102a are submerged in a fluid source, such as, for example, a glass containing a consumable fluid. A user applies suction to the second end 102b causing a quantity of the consumable fluid to flow into/through the fluid channel 100. The bi-directional flow meter 2 records the quantity of fluid flowing through the fluid channel 100 while the user is applying suction.

When suction is removed from the second end 102b, for example, after a user has consumed a desired quantity of the fluid, the fluid remaining in the fluid channel 100 flows out of the first opening 102a back into the fluid source up to the fluid level of the fluid source. The “flow back” amount that flows back into the fluid source is recorded by the bi-directional flow meter 2. The flow back amount can be subtracted from the forward flow amount to determine a quantity of consumable fluid consumed by the user. In some embodiments, the bi-directional flow meter 2 transmits flow information to a remote system which calculates the quantity of fluid consumed by the user. The fluid information can be tracked by the user and/or a third party (such as a medical professional associated with the user, a dietician, etc.) to monitor calorie consumption, hydration, and/or any other suitable aspect of fluid consumption.

In some embodiments, the bi-directional flow meter 2 and fluid channel 100 can be used to monitor fluid output of a fluid source, such as urine output of a medical patient, output of a water source, and/or any other suitable output. The bi-directional flow meter 2 is coupled to a first side 102a of the fluid channel 100. The fluid channel 100 can include any suitable fluid channel 100, such as, for example, a catheter tube, collection bag, and/or any other suitable fluid path. Fluid flows into the fluid channel 100 from a second end 102b. The bi-directional flow meter 2 monitors the flow rate and direction of flow of fluid flowing into the fluid channel 100 to monitor patient output and/or to ensure proper operation of the fluid channel 100 (i.e., fluid channel restricted to flow only into holding container).

In some embodiments, the bi-directional flow meter 2 includes at least one reusable portion. For example, in some embodiments, the electronics module 6 is reusable for multiple fluid path cartridges 4 and/or in multiple environments. For example, in the embodiment discussed above measuring urine output of a medical patient, a hospital may utilize a single electronics module 6 for multiple fluid path cartridges 4. The hospital sanitizes the electronics module 6 and couples the electronics module 6 to a first fluid path cartridge 4. The electronics module 6 monitors fluid output of a first patient coupled to the first fluid path cartridge 4. After monitoring of a patient is complete, the electronics module 6 is removed from the first fluid path cartridge 4. The fluid path cartridge 4 is discarded and the electronics module 6 is treated, for example, through sterilization. After being treated, the electronics module 6 can be coupled to a second fluid path cartridge 4 for monitoring fluid output of a second patient.

In some embodiments, a single electronics module 6 can be selectively coupled to multiple fluid path cartridges to monitor fluid intake/output from multiple sources. A first fluid path cartridge 4 is coupled to a first fluid source, such as, for example, a straw. A second fluid path cartridge 4 is coupled to a second fluid source, such as, for example, a back hydration system (e.g., hydration backpack). A single electronics module 6 can be selectively coupled to the first fluid path cartridge 4 and/or the second fluid path cartridge 4. The single electronics module 6 can be used to monitor total fluid intake, for example, by a user, from the first and second fluid sources. A user can attach the electronics module 6 to the first fluid path cartridge when consuming a fluid from the first fluid source. The user can then detach the electronics module 6 from the first fluid path cartridge 4 and attach the electronics module 6 to the second fluid path cartridge 4 when consuming a fluid from the second fluid source. In some embodiments, a single electronics module 6 can be coupled to any number of fluid path cartridges and/or fluid sources. In some embodiments, multiple fluid path cartridges 4 and/or electronics modules 6 can be interchangeably coupled together. The flow information collected by each of the electronics modules 6 can be aggregated by a remote system.

In some embodiments, a bi-directional flow meter 2 can be configured to monitor fluid flow between a first container and at least a second container. For example, in embodiment including laboratory environments, it may be desired to have fluid transfer back and forth between a first container and a second container based on one or more parameters, such as experimental parameters. A bi-directional flow meter 2 can be coupled between the first container and the second container to monitor fluid flow direction and quantity to ensure proper movement of the fluid. Although specific embodiments are discussed herein, it will be appreciated that the bi-directional flow meter 2 can be coupled to any suitable fluid source and/or fluid path to monitor direction and/or quantity of fluid flow through the fluid path, and is not limited to only those embodiments described herein.

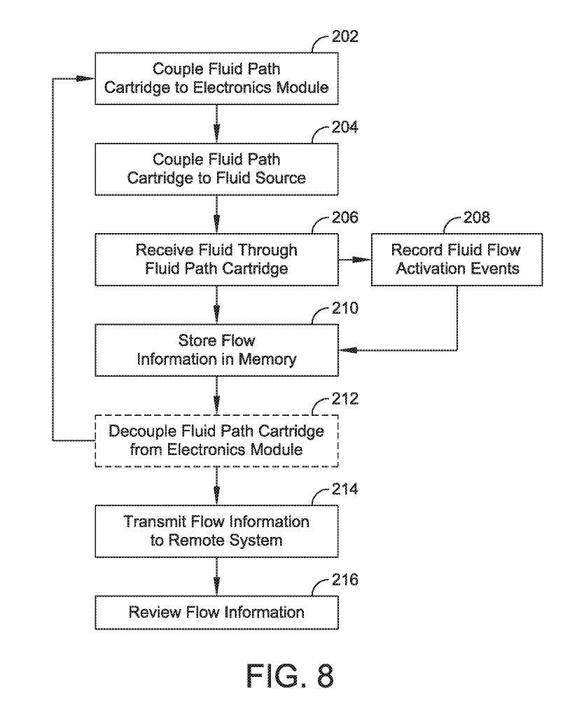

FIG. 8 is method of use for a bi-directional flow meter 2, in accordance with some embodiments. At step 202, a first fluid path cartridge 4 is releasably and/or permanently coupled to an electronics module 6. At step 204, the first fluid path cartridge 4 is coupled to a first fluid source at a first opening 12a of a fluid path 10. At step 206, fluid flows through the fluid path 10 defined by the first fluid path cartridge. At step 208, the electronics module 6 records the direction of flow and/or the rate of flow for the flow event. For example, in some embodiments, the electronics module 6 includes a plurality of switches 44a, 44b that are activated in a predetermined pattern by rotation of a magnetic element 32 within the first fluid path cartridge 4. The processor 48 monitors the activation of pattern of the switches 44a, 44b and determines a direction of rotation (corresponding to a direction of fluid flow) and a rate of rotation (corresponding to a rate of fluid flow) of the magnetic element 32. At optional step 210, the flow information is stored in a memory module 50 formed integrally with the electronics module 6.

At optional step 212, the electronics module 6 is decoupled from the first fluid path cartridge. The method 200 returns to step 202 and a second fluid path cartridge 4 is releasably and/or permanently coupled to the electronics module 6. The bi-directional flow meter assembly 2 is coupled to a second fluid source at a first opening 12a of the fluid path 10 (at step 204) and fluid flows through the fluid path 10 (at step 206). The electronics module 6 records fluid flow events for the second fluid path cartridge 4. The electronics module 6 can be selectively connected to any number of fluid path cartridges 4.

At step 214, the electronics module 6 transmits the recorded flow data to a remote system. The electronics module 6 can transmit the recorded flow data simultaneously with the recording of the flow data and/or after recording the flow data. In some embodiments, the electronics module 6 automatically transmits recorded flow data to a remote system when a connection is established between the electronics module 6 and the remote system. A connection can be established using any suitable communication system, such as, for example, a wired and/or wireless communication system. At step 216, the transmitted flow data can be reviewed for one or more parameters, such as quantity of fluid flow, overall direction of fluid flow, and/or any other suitable parameters.

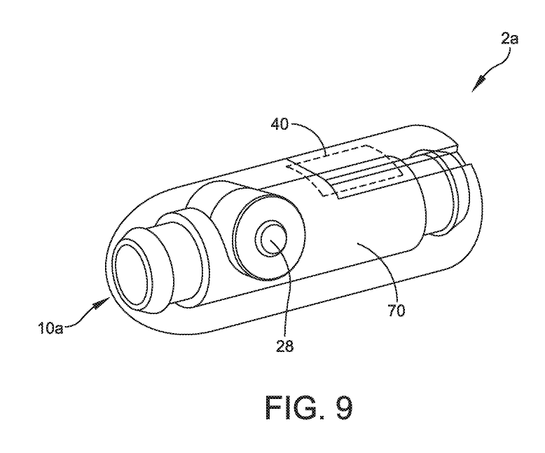

Although embodiments are discussed herein including a flow path cartridge 4 and an electronics module 6 having separate housings 8, 16, it will be appreciated that the flow path 10, flow measuring element 28, and a circuit 40 can be located within a single housing. For example, FIG. 9 illustrates a bi-directional flow meter 2a including a housing 70 defining a flow path 10a and having a flow sensing element 28 and a circuit 40 disposed therein. The circuit 40 is positioned within a portion of the housing 70 that is hermetically sealed from the flow path 10a and the flow sensing element 28 to prevent interaction between the circuit 40 and a fluid flowing through the flow path 10a. The bi-directional flow meter 2a is similar to the bi-directional flow meter 2 described above, and similar description is not repeated herein.

The bi-directional flow meter 2a can be reusable and/or disposable. For example, in some embodiments, the circuit 40 is hermetically sealed from the flow path 10a and the flow sensing element 28. The bi-directional flow meter 2 can be subjected to a cleaning and/or sterilizing process without damaging the circuit 40. The bi-directional flow meter 2a is suitable for use in any of the applications and/or methods previously described in conjunction with the bi-directional flow meter 2.

Although the subject matter has been described in terms of exemplary embodiments, it is not limited thereto. Rather, the appended claims should be construed broadly, to include other variants and embodiments, which may be made by those skilled in the art.

What is claimed is:

1. A flow meter, comprising:
a first body defining a fluid path;
a flow measuring element operatively positioned within the fluid path, wherein the flow measuring element is configured to generate a signal in response to fluid within the fluid path; and
at least one circuit element configured to receive the signal generated by the measuring element and determine a rate of flow and a direction of flow of the fluid within the fluid path.

2. The flow meter of claim 1, wherein the flow measuring element comprises a magnetic element.

3. The flow meter of claim 2, wherein the flow measuring element comprises a paddle wheel having a cylindrically magnetized magnet coupled thereto, wherein the paddle wheel is rotated by the fluid in the fluid path.

5. The flow meter of claim 4, wherein the at least one circuit element comprises a first magnetic switch and a second magnetic switch.

6. The flow meter of claim 5, wherein the first and second switches are activated in a predetermined activation pattern based on the direction of flow of the fluid in the fluid path.

7. The flow meter of claim 1, wherein the first body defines a flow path cartridge, and wherein the at least one circuit element is disposed within a second body releasably coupled to the first body.

8. The flow meter of claim 7, wherein the second body is hermetically sealed.

9. The flow meter of claim 1, comprising a processor configured to determine the rate of flow and direction of flow of the fluid, a memory unit configured to store the rate of flow and direction of flow of the fluid, and a communications module configured to transmit the rate of flow and direction of flow of the fluid to a remote system.

10. The flow meter of claim 1, wherein the fluid path defined by the body is defined by a first opening in a proximal end of the body, a second opening in a distal end of the body, and a channel extending along a longitudinal axis of the body between the first opening and the second opening.

11. A system, comprising:
a bi-directional flow meter, comprising:
a first flow path cartridge comprising a body defining a fluid path and a flow measuring element operatively positioned within the fluid path, the flow measuring element comprising a paddle wheel having a plurality of paddles operatively positioned within the fluid path and a cylindrically magnetized magnet coupled thereto; and
an electronics module releasably coupled to the flow path cartridge; and
a fluid channel operatively coupled to the fluid path of the first flow path cartridge, wherein the fluid channel is configured to receive a fluid therethrough, and wherein the electronics module is configured to determine a rate of flow and a direction of flow of the fluid in the fluid channel.

12. The system of claim 11, comprising:
a second flow path cartridge comprising a body defining a fluid path and a flow measuring element operatively positioned within the fluid path, wherein the second flow path cartridge is selectively releasably coupled to the electronics module.

13. The system of claim 11, wherein the electronics module includes a first magnetic element and a second magnetic element configured to respond to the cylindrically magnetized magnet in the first fluid path cartridge, and wherein an activation pattern of the first magnetic element and the second magnetic element indicate the direction of flow of the fluid in the fluid channel.

14. The system of claim 13, wherein the first magnetic element comprises a first magnetic switch and the second magnetic element comprises a second magnetic switch.

15. The system of claim 11, wherein the fluid channel is configured to provide a consumable liquid to a user.

16. The system of claim 11, wherein the fluid channel is configured to receive a fluid discharge from a fluid source.

17. A method of measuring a direction and quantity of flow of a fluid in a fluid channel, comprising:
coupling a bi-directional flow meter to a first end of the fluid channel, the bi-directional flow meter comprising a flow path cartridge releasably coupled to an electronics module, wherein the flow path cartridge comprises a body defining a fluid path and a flow measuring element operatively positioned within the fluid path;
receiving a fluid within the fluid channel and the fluid path defined by the fluid cartridge;
determining a rate of flow of the fluid within the fluid channel, wherein the rate of flow is determined by the flow measuring element; and
determining a direction of flow of the fluid within the fluid channel, wherein the direction of flow is determined by one or more circuit elements in the electronics module.

18. The method of claim 17, wherein the one or more circuit elements in the electronics module comprise a first magnetic switch and a second magnetic switch, and wherein determining a direction of flow of the fluid comprises determining an activation pattern for the first magnetic switch and the second magnetic switch, wherein the flow measuring element comprises a magnetic element coupled to a paddle wheel operatively positioned to rotate in response to fluid in the fluid path, and wherein the first magnetic switch and the second magnetic switch are operated by rotation of the magnetic element.

19. The method of claim 18, wherein a rate of flow of the fluid within the fluid channel is determined by measuring the number of activation patterns completed by the first magnetic switch and the second magnetic switch within a predetermined time period.

20. The method of claim 17, comprising transmitting the direction of flow and the rate of flow of the fluid within the fluid channel to a remote system.
